(19) United States
(12) Patent Application Publication
(10) Pub. No.: US 2016/0196550 A1
(43) Pub. Date: Jul. 7, 2016

(54) Electronic Personal Wallet System and Methods of Use

(71) Applicant: WUL4, LLC, Cordoba (ES)

(72) Inventor: Abdul Ghafoor Chaudhry Basit, Robledo de Chavela (ES)

(73) Assignee: WUL4, LLC, Cordoba (ES)

(21) Appl. No.: 14/590,835

(22) Filed: Jan. 6, 2015

(51) Int. Cl. G06Q 20/36; G06K 19/077; H02J 7/00; G06K 19/07

(52) U.S. Cl. CPC G06Q 20/363; G06K 19/0704; G06K 19/07707; G06K 19/07762; H02J 7/0044; H02J 7/0054

(57) ABSTRACT

An electronic wallet system and associated methods of use are disclosed. In at least one embodiment, the system includes an at least one wallet device in the possession of a user and configured for securely storing data related to said user, and an at least one vendor device in the possession of a vendor. Each wallet device provides a portable wallet housing containing an at least one wallet display, a wallet transceiver configured for sending and receiving data related to the user, an at least one rechargeable battery, and an at least one wallet charging contact. Each vendor device provides a vendor housing containing a vendor transceiver configured for sending and receiving select data to and from the wallet transceiver, and an at least one vendor charging contact configured for transferring power to the wallet device via the at least one wallet charging contact.

### RELATED APPLICATIONS

Not applicable.

### BACKGROUND

The subject of this patent application relates generally to digital wallets, and more particularly to an electronic wallet system and associated methods of use.

Applicant(s) hereby incorporate herein by reference any and all patents and published patent applications cited or referred to in this application.

By way of background, conducting payment transactions using mobile devices, such as smartphones, tablets and the like, is becoming increasingly popular as it provides additional layers of abstraction and security with respect to a consumer's credit card and banking information. The need for secure communication systems is not unique to the payment transaction context. Marketing and consumer loyalty solutions have also begun to utilize various mobile communication protocols in order to interact with consumers while they are on the go, or even while consumers are physically located in a particular merchant's store. These solutions have also begun to replace the use of physical loyalty or rewards cards. Identity verification and access control solutions are also beginning to incorporate mobile devices.

The term “digital wallet” (or “electronic wallet”) is commonly used to refer generally to such electronic devices and/or software applications that allow an individual to engage in electronic transactions utilizing select information related to that individual as stored on—or otherwise accessible by—the device or software. Thus, not only can an individual's bank account and credit cards be linked to a digital wallet, but also their driver's license, health cards, loyalty cards, gift cards, etc. In certain instances, this stored information can be passed to a vendor's (such as a merchant or access controller) terminal wirelessly. Some speculate that these digital wallets will eventually replace physical wallets. However, there are many drawbacks with respect to current digital wallet solutions.

For example, many such digital wallet solutions that are configured for physically interacting with another device—such as a terminal or point-of-sale (“POS”) system positioned within a retail establishment for the purpose of facilitating payment transactions or accessing customer loyalty information—typically utilize near field communication (“NFC”) for carrying out the wireless communication therebetween. However, only a small percentage of mobile devices and POS systems currently on the market actually contain the hardware necessary to support NFC functionality. Furthermore, given that NFC is a form of radio-frequency identification, such communications can potentially be eavesdropped or intercepted by unauthorized entities using the appropriate equipment.

Additionally, many hardware manufacturers, mobile network operators, software providers, banks and bank associations, credit card providers, and other entities provide various types of entity-specific digital wallet solutions—or at least solutions that are not configured for functioning as a “universal” solution that would accommodate all potential forms of information related to a given individual. As a result, users are often required to maintain multiple such digital wallets depending on the particular credit cards, loyalty cards, etc. they wish to utilize in a digital wallet format. Furthermore, in most cases, such digital wallets are not are not interoperable.

With respect to mobile-based digital wallets, wherein the digital wallet is stored in memory on a mobile device such as a smartphone, the availability of the digital wallet is dependent on the availability of the mobile device—i.e., if the mobile device battery dies, or the mobile device otherwise becomes inoperable, then so too does the digital wallet. Additionally, given that most such mobile devices contain a number of various third party applications, such an environment increases the chances of the mobile device being hacked through the exploitation of potential vulnerabilities in such third party applications which could, in turn, compromise the security of the personal information maintained by the digital wallet. Still further, not everyone who is interested in utilizing a digital wallet has—or is even interested in owning—a mobile device capable of supporting such functionality.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing an electronic wallet system and associated methods of use. In at least one embodiment, the system includes an at least one wallet device in the possession of a user and configured for securely storing data related to said user. Each wallet device provides a portable wallet housing. An at least one wallet display is positioned on the wallet housing and configured for allowing the user to selectively interact with the wallet device. A wallet transceiver is positioned on the wallet housing and configured for sending and receiving data related to the user. An at least one rechargeable wallet battery is positioned within the wallet housing and configured for selectively powering the wallet device. An at least one wallet charging contact is positioned on the wallet housing and configured for selectively powering the wallet device and charging the wallet battery when placed in contact with an appropriate charging unit. The system also includes an at least one vendor device in the possession of a vendor and configured for selectively interacting with the at least one wallet device. Each vendor device provides a vendor housing. A vendor transceiver is positioned on the vendor housing and configured for sending and receiving select data to and from the wallet transceiver of the at least one wallet device. An at least one vendor charging contact is positioned on the vendor housing and configured for transferring power to the wallet device when the corresponding at least one wallet charging contact is selectively placed into contact therewith. Thus, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary electronic wallet system, in accordance with at least one embodiment;

FIG. 2 is a front plan view of an exemplary wearable electronic wallet device, in accordance with at least one embodiment;

FIG. 3 is a rear plan view thereof, in accordance with at least one embodiment;

FIG. 4 is a top perspective view thereof, in accordance with at least one embodiment;

FIG. 5 is a side perspective view thereof, in accordance with at least one embodiment;

FIG. 6 is a front plan view of an exemplary vendor device, in accordance with at least one embodiment;

FIG. 7 is a side plan view thereof, in accordance with at least one embodiment;

FIG. 8 is a perspective view of an exemplary wallet device wristband, in accordance with at least one embodiment;

FIG. 9 is a simplified diagrammatic view thereof, in accordance with at least one embodiment; and

FIGS. 10-12 are flow diagrams of exemplary methods for securely storing, transmitting and processing select data related to a user of the exemplary wallet device, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

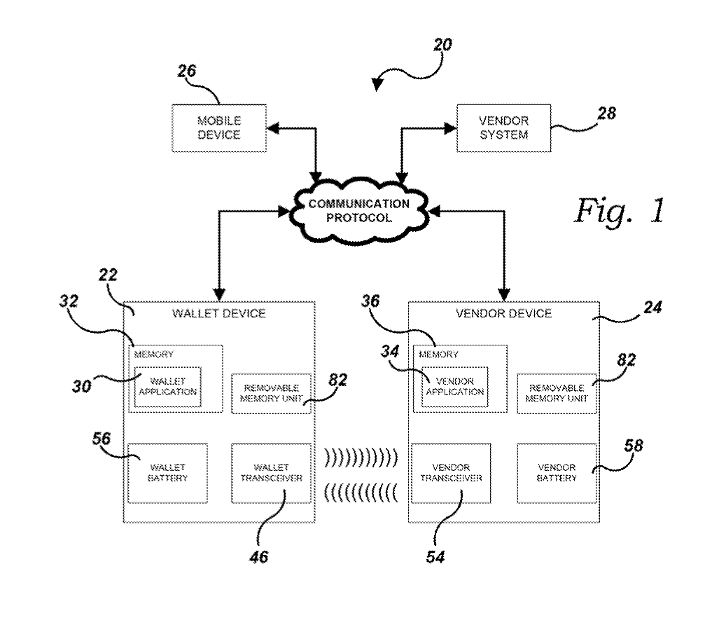

Turning now to FIG. 1, there is shown a simplified schematic view of an exemplary electronic wallet system 20. The system 20 provides, in at least one embodiment, an at least one wearable electronic wallet device 22 (hereinafter referred to generally as a “wallet device”) and an at least one vendor device 24 in selective communication with the wallet device 22. In at least one embodiment, as discussed further below, the at least one wallet device 22 is also in selective communication with an at least one mobile device 26. Additionally, in at least one embodiment, as discussed further below, the at least one vendor device 24 is in communication with a larger corresponding vendor system 28, depending on the context in which the vendor device 24 is utilized. Examples of such vendor systems 28 may include—but are certainly not limited to—point-of-sale (“POS”) systems, vending machines, unattended terminals, access control devices, point-of-interaction (“POI”) systems, etc. Similarly, it should also be noted that the term “mobile device” is intended to include any type of mobile computing or electronic device now known or later developed, such as mobile phones, smartphones, laptop computers, tablet computers, personal data assistants, gaming devices, etc.

At the outset, it should be noted that communication between each of the at least one wallet device 22, at least one mobile device 26, at least one vendor device 24, and at least one vendor system 28 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes.

With continued reference to FIG. 1, in the exemplary embodiment, each of the wallet device 22 and vendor device 24 contains the hardware and software necessary to carry out the exemplary methods for securely storing, transmitting and processing select data related to a user of the wallet device 22 as described herein. In at least one embodiment, each wallet device 22 provides a wallet application 30 residing in memory 32 on the wallet device 22, while each vendor device 24 provides a vendor application 34 residing in memory 36 on the vendor device 24; the functionality of each is described further below. It should be noted that the term “memory” is intended to include any type of electronic storage medium (or combination of storage mediums) now known or later developed, such as local hard drives, solid state drives, RAM, flash memory, secure digital (“SD”) cards, external storage devices, network or cloud storage devices, etc. Furthermore, the various components of each wallet device 22 and vendor device 24 may reside in memory on a single computing or electronic device, or may separately reside on two or more computing or electronic devices in communication with one another. In at least one embodiment, the wallet device 22 is in the possession of a user who is desirous of interacting with the at least one vendor device 24 as described further below. Similarly, in at least one embodiment, the at least one vendor device 24 is in the possession or control of a participating vendor from whom the user is desirous of acquiring some good, service or other benefit. It should be noted that, in at least one embodiment, the term “vendor” is intended to generally include any type of entity in the business of providing goods, services, or any other benefit now known or later conceived, to the at least one user, including but not limited to manufacturers, merchants, retailers, service providers, lenders, facility access managers, law enforcement, public transportation providers, website owners, etc.

As illustrated in FIGS. 2-5, in at least one embodiment, the various components of the wallet device 22 are contained within a wallet housing 38 that is sized for allowing the wallet device 22 to be portable. As a result, in such embodiments, the wallet device 22 is capable of being worn or otherwise carried by the user in a variety of different ways, as discussed further below. In at least one embodiment, a front face 40 of the wallet housing 38 provides an at least one wallet display 42, while an opposing rear face 44 of the wallet housing 38 provides an infrared (“IR”) wallet transceiver 46. In at least one alternate embodiment, the wallet transceiver 46 may be positioned anywhere else on the wallet housing 38, including on the front face 40 of the wallet housing 38 with the wallet display 42, or on a side wall 48 of the wallet housing 38. At the outset, it should be noted that the particular size, shape and configuration of the wallet device 22 as shown in the accompanying drawings is merely exemplary. Accordingly, in further embodiments, the wallet device 22 may take on any other size, shape, and/or configuration, now known or later conceived, so long as the wallet device 22 is capable of substantially carrying out the functionality described herein.

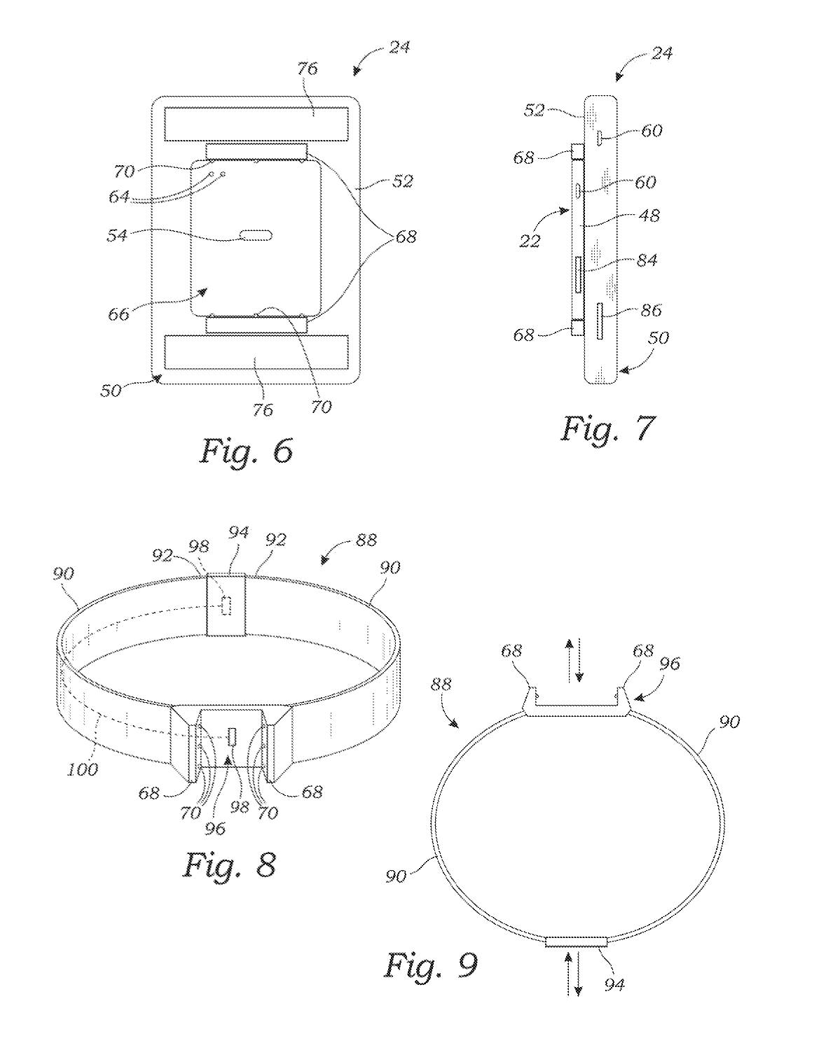

As illustrated in FIGS. 6 and 7, in at least one embodiment, the vendor device 24 similarly provides a vendor housing 50. A front face 52 of the vendor housing 50 provides an infrared vendor transceiver 54 positioned and configured for sending and receiving select data to and from the wallet transceiver 46, as discussed further below. In the exemplary embodiment, use of infrared signals (as opposed to radio signals) avoids electromagnetic (“EM”) pollution and the possibility of damaging other devices (such as magnetic stripes). Infrared signals are also more difficult to eavesdrop on or intercept as compared to radio signals, while also having greater range than communication protocols like NFC. It should be noted that while the wallet transceiver 46 and vendor transceiver 54 are described herein as being infrared transceivers, the wallet and vendor transceivers 46 and 54 may incorporate any other “point-to-point” communication protocols, now known or later developed, in further embodiments. In still further embodiments, the wallet and vendor transceivers 46 and 54 may incorporate any other type of communication protocol now known or later developed, such as NFC. As such, the wallet and vendor transceivers 46 and 54 should not be read as being so limited. At the outset, it should be noted that the particular size, shape and configuration of the vendor device 24 as shown in the accompanying drawings is merely exemplary. Accordingly, in further embodiments, the vendor device 24 may take on any other size, shape, and/or configuration, now known or later conceived, so long as the vendor device 24 is capable of substantially carrying out the functionality described herein.

With continued reference to FIGS. 1-7, in at least one embodiment, the wallet device 22 provides an at least one rechargeable wallet battery 56 positioned within the wallet housing 38 and configured for selectively powering the wallet device 22. In at least one embodiment, the vendor device 24 also provides an at least one rechargeable vendor battery 58 positioned within the vendor housing 50 and configured for selectively powering the vendor device 24. In at least one alternate embodiment, where the vendor device 24 is intended to remain relatively stationary (for example, where the vendor device 24 is used in the context of a point-of-sale system or an unattended access terminal), the vendor device 24 is configured for being powered by one or a combination of AC and DC power supplies. In a bit more detail, in at least one such embodiment, the vendor device 24 provides an AC jack (not shown) configured for receiving a AC adapter, thereby enabling the vendor device 24 to operate on AC power as well as recharge the vendor battery 58 as needed (where a vendor battery 58 is incorporated in the vendor device 24). It will be appreciated that it is advantageous to have a vendor battery 58 as part of the vendor device 24 in the event of a power outage. It should be noted, however, that other types of power supplies, now known or later developed, such as other types of rechargeable batteries or AC power (including docking stations), may be substituted. Additionally, similar recharging or AC power capability, in terms of the batteries themselves and/or the necessary jacks, adapters and the like are all possible as part of the vendor device 24 without departing from the spirit and scope of the present invention. In at least one embodiment, the wallet device 22 may similarly be configured for being powered by one or a combination of AC and DC power supplies, and provide an appropriate interface for receiving such power in order to recharge the wallet battery 56 as needed. In still further embodiments, each of the wallet device 22 and vendor device 24 provides a universal serial bus (“USB”) port 60, such as a micro-USB port, configured for receiving power when connected to an appropriate source. Additionally, the USB port 60 may be used for data transfer purposes, as discussed further below. In at least one such embodiment, the USB port 60 provides a hinged closure (not shown) configured for selectively sealing the USB port 60 in order to protect it from water, dust and other environmental elements.

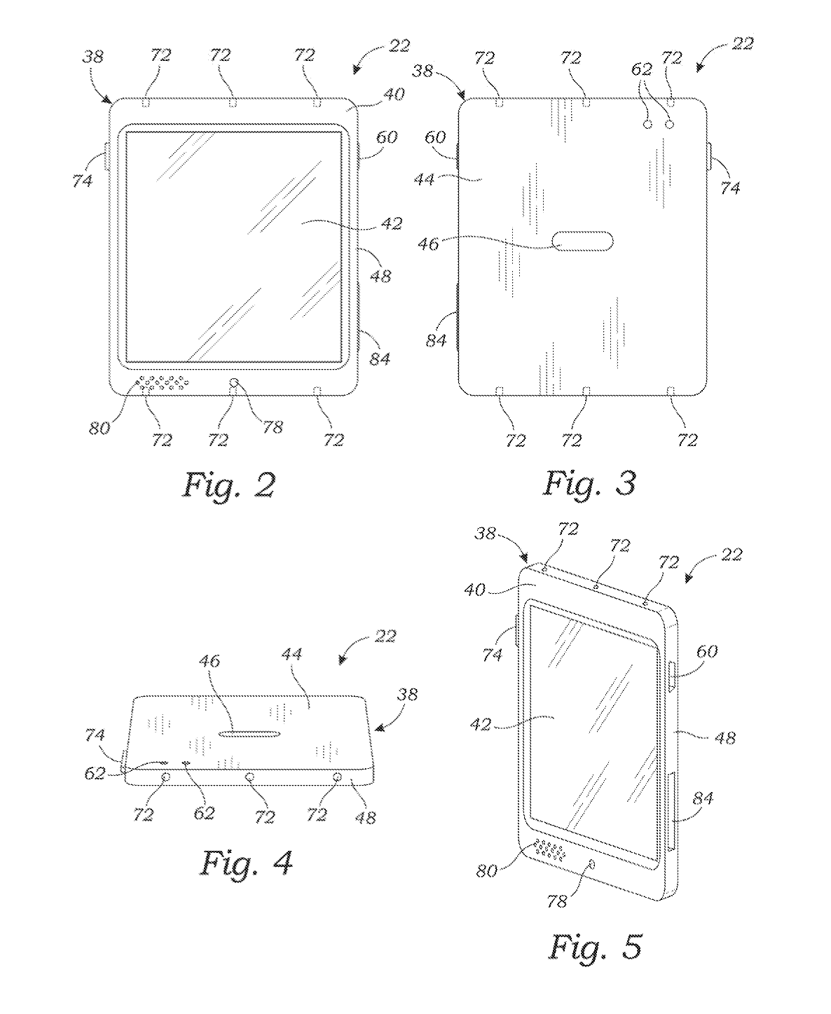

As best shown in FIG. 3, in at least one embodiment, the rear face 44 of the wallet housing 38 provides an at least one wallet charging contact 62 positioned and configured for selectively powering the wallet device 22 and charging the wallet battery 56 when placed in contact with an appropriate charging unit, such as the vendor device 22. As shown best in FIG. 6, in at least one embodiment, the front face 52 of the vendor housing 50 provides an at least one corresponding vendor charging contact 64 positioned and configured for transferring power to the wallet device 22 when the wallet and vendor charging contacts 62 and 64 are selectively placed into contact with one another. In this way, even if the wallet device 22 lacks sufficient power on its own to interact with the vendor device 24 (as discussed further below)—for example, if the wallet battery 56 is dead—it may nevertheless receive the necessary power from the vendor device 24. Thus, the wallet device 22 is capable of always being operational. In at least one such embodiment, the front face 52 of the vendor housing 50 provides a wallet dock 66 sized and configured for removably receiving the wallet device 22 therewithin, such that the rear face 44 of the wallet housing 38 contacts the front face 52 of the vendor housing 50. Additionally, the at least one vendor charging contact 64 and vendor transceiver 54 are positioned such that, when the wallet device 22 is positioned within the wallet dock 66, they are substantially aligned with the at least one wallet charging contact 62 and wallet transceiver 46, respectively. In this way, when the wallet device 22 is docked with the vendor device 24, the wallet device 22 is able to be selectively powered by the vendor device 24, and select data is able to be transferred via the wallet and vendor transceivers 46 and 54 in a secure manner. In at least one embodiment, the wallet dock 66 provides a pair of opposing, spaced apart spring pin arrays 68 positioned and configured such that the spring pins 70 selectively index into corresponding retaining holes 72 positioned along the side wall 48 of the wallet housing 38. In at least one such embodiment, the spring pin arrays 68 and the retaining holes 72 may be configured for transferring power therebetween, in lieu of the wallet and vendor charging contacts 62 and 64. In further embodiments, any other means for allowing the wallet device 22 to be removably engaged with the wallet dock 66, now known or later developed, may be substituted. For example, the removable engagement may be achieved through corresponding magnets, or retaining clips, or friction, etc. Thus, it will be appreciated that the spring pin arrays 68 are merely used as an exemplary embodiment of such functionality. Similarly, in further embodiments, any other means for transferring power from the vendor device 24 to the wallet device 22, now known or later developed, may be substituted. For example, the power transfer may be achieved through induction charging, or charging pins, or the USB port 60, etc. Thus, it will be appreciated that the wallet and vendor charging contacts 62 and 64 are merely used as an exemplary embodiment of such functionality. Additionally, in alternate embodiments, the wallet and vendor charging contacts 62 and 64 may be positioned anywhere else on the wallet housing 38 and vendor housing 50, respectively.

Referring again to FIG. 2, in at least one embodiment, the wallet device 22 is configured for going into a “stand-by” mode, after a pre-defined period of inactivity has elapsed, to both save battery life and for security. In such embodiments, the wallet device 22 provides a stand-by button 74 configured for waking the wallet device 22 when it is in stand-by mode. In at least one further embodiment, the stand-by button 74 may be further configured for selectively putting the wallet device 22 into stand-by mode during use, and also for selectively powering the wallet device 22 on and off as desired.

As mentioned above, in at least one embodiment, the front face 40 of the wallet housing 38 provides the at least one wallet display 42 (FIG. 2). In a bit more detail, the wallet display 42 is configured for displaying appropriate user interfaces as generated by the wallet application 30, depending on the context in which the wallet device 22 is being used at any given time (as discussed further below). In at least one such embodiment, the wallet display 42 is a touchscreen configured for allowing the user to interact with the user interfaces displayed thereon (as also discussed further below). Similarly, in at least one embodiment, as shown in FIG. 6, the front face 52 of the vendor housing 50 provides an at least one vendor display 76. Similar to the wallet display 42, the vendor display 76 is configured for displaying appropriate user interfaces as generated by the vendor application 34, depending on the context in which the vendor device 24 is used. The vendor display 76 may also be configured for displaying instructional, promotional, or advertising content—again, depending on the context in which the vendor device 24 is used.

With continued reference to FIG. 2, in at least one embodiment, the wallet device 22 further provides an at least one microphone 78 positioned and configured for receiving voice commands from the user as an alternative means for interacting with the user interfaces displayed by the wallet display 42. In at least one further embodiment, to accommodate users having visual impairments, the wallet device 22 may incorporate at least one of an audio jack (not shown) for connecting headphones, and a speaker 80. In such embodiments, the wallet application 30 is capable of producing text-to-speech audio via the audio jack and/or speaker 80.

In many contexts in which the wallet device 22 may be used, the select user-related data being stored in memory 32 on the wallet device 22 may be very sensitive or otherwise important—i.e., social security number, credit card numbers, bank account numbers, etc. Accordingly, in at least one embodiment, the wallet device 22 incorporates a removable memory unit 82 configured for securely storing such user-related data. Not only does this allow the data to be encrypted, but it also better ensures that the data will not be lost in the event the wallet device 22 becomes damaged or suffers a catastrophic failure. Storing such data on the removable memory unit 82 also allows the user to store user-related data across multiple removable memory units 82, and also allows multiple users (perhaps in a given family or household) to utilize the same wallet device 22 by simply inserting the removable memory unit 82 associated with the appropriate user. In one such embodiment, as shown in FIG. 5, the removable memory unit 82 is a microSD card accessible via a wallet card slot 84 provided by the wallet housing 38. Similarly, in at least one embodiment, the vendor device 24 also incorporates a removable memory unit 82. In one such embodiment, as shown in FIG. 7, the removable memory unit 82 is a microSD card accessible via a vendor card slot 86 provided by the vendor housing 50. It should be noted that, in further embodiments, each of the wallet device 22 and vendor device 24 may utilize any other type of removable memory, now known or later developed. In at least one embodiment, the wallet card slot 84 provides a hinged closure (not shown) configured for selectively sealing the wallet card slot 84 in order to protect it from water, dust and other environmental elements.

As mentioned above, in at least one embodiment, the wallet device 22 is also in selective communication with the at least one mobile device 26. In a bit more detail, in at least one embodiment, this selective communication allows the mobile device 26—once loaded with an appropriate mobile application—to share select information with the wallet device 22 or to even control or otherwise utilize the wallet device 22 via the mobile device 26. In at least one such embodiment, the selective communication is achieved using Bluetooth. However, in further such embodiments, any other communication protocol, now known or later developed, may be substituted. In at least one embodiment, the vendor device 24 may also provide a similar communication protocol for enabling selective communication with the at least one mobile device 26 for similar purposes.

As also mentioned above, the wallet device 22 is capable of being worn or otherwise carried by the user in a variety of different ways. In at least one embodiment, as shown in FIGS. 8 and 9, the wallet device 22 provides a wristband 88 sized and configured for removably receiving the wallet device 22 so that the wallet device 22 may be worn around a wrist of the user. In this way, the wallet device 22 is relatively easier and more convenient to carry than a traditional smartphone or tablet; it's also more difficult to accidentally lose or leave behind if it is being worn by the user. In a bit more detail, in at least one such embodiment, the wristband 88 provides a strap portion 90 configured for being removably engaged around the user's wrist. In one embodiment, the strap portion 90 is relatively elongate, having opposing free ends 92, and provides a closure portion 94 configured for selectively securing the free ends 92 to one another for engagement around the user's wrist. In an alternate embodiment, the strap portion 90 is a continuous ring-shaped band capable of stretching to fit over a hand of the user for engagement around the user's wrist. In at least one such embodiment, the wristband 88 provides a wallet receptacle 96 sized and configured for removably receiving the wallet device 22 therewithin. Similar to the wallet dock 66 of the exemplary vendor device 24, in at least one embodiment, the wallet receptacle 96 provides a pair of opposing, spaced apart spring pin arrays 68 positioned and configured such that the spring pins 70 selectively index into the corresponding retaining holes 72 positioned along the side wall 48 of the wallet housing 38. In further embodiments, any other means for allowing the wallet device 22 to be removably engaged with the wallet receptacle 96, now known or later developed, may be substituted. For example, the removable engagement may be achieved through corresponding magnets, or retaining clips, or friction, etc. Thus, again, it will be appreciated that the spring pin arrays 68 are merely used as an exemplary embodiment of such functionality. In at least one embodiment, the wristband 88 provides an at least one transceiver relay 98 positioned and configured for interfacing with the wallet transceiver 46, when the wallet device 22 is engaged with the wallet receptacle 96, so as to relay data signals to and from the wallet transceiver 46. In at least one such embodiment, a first one of the at least one transceiver relay 98 is positioned on the wallet receptacle 96 such that, when the wallet device 22 is engaged with the wallet receptacle 96, the first one of the at least one transceiver relay 98 is substantially aligned with the wallet transceiver 46. In at least one embodiment, the wristband 88 provides a second one of the at least one transceiver relay 98 in a position substantially opposite to that of the first one of the at least one transceiver relay 98 so as to allow the data signals to be relayed to and from the wallet transceiver 46 in two substantially opposing directions, as illustrated best in FIG. 9. In this way, the user is able to selectively orient the wallet device 22 in two different positions when interacting with the vendor device 24, thereby making the wallet device 22 relatively easier and more comfortable to use. In one such embodiment, the second one of the at least one transceiver relay 98 is positioned within the closure portion 94. In still further embodiments, the wristband 88 may provide even more transceiver relays 98 along the length of the strap portion 90, thereby creating further orientations in which the wallet device 22 may interact with the vendor device 24. In at least one embodiment, as illustrated in FIG. 8, each of the at least one transceiver relay 98 and the wallet transceiver 46 are interconnected via an at least one transmission line 100 embedded in the strap portion 90. In the exemplary embodiment, where the wallet and vendor transceivers 46 and 54 are infrared transceivers, the at least one transceiver relay 98 is an optical coupler, and the at least one transmission line 100 is an optical fiber. In further embodiments where the wallet and vendor transceivers 46 and 54 use a communication protocol other than infrared, the at least one transceiver relay 98 and transmission line 100 shall be substituted with appropriate components compatible with such alternate communication protocols in carrying out the above-described functionality. It should also be noted that the particular size, shape and configuration of the wristband 88 as shown in the accompanying drawings is merely exemplary. Accordingly, in further embodiments, the wristband 88 may take on any other size, shape, and/or configuration, now known or later conceived, so long as the wristband 88 is capable of substantially carrying out the functionality described herein. In still further embodiments, again, the wallet device 22 may be worn or otherwise carried in any number of different ways, now known or later conceived, such as via a necklace, a ring, a belt or even simply in a pocket of the user's clothing. These are merely exemplary illustrations of the variety of ways the wallet device 22 may be carried by the user and should not be read as being limiting in any way.

As discussed in detail below, the system 20 may be utilized in a variety of contexts. In each such context, data exchange between the wallet device 22 and the vendor device 24 is achieved via the wallet transceiver 46 and vendor transceiver 54, respectively. In the exemplary embodiment, the wallet device 22 is capable of storing all pertinent data related to, and handling nearly every operation a user could potentially perform with, any item traditionally stored in their physical wallet or purse—thereby eliminating the need to physically carry such items. For example, the wallet device 22 may be configured for securely storing, transmitting and processing select data related to financial transactions using appropriate financial instruments (i.e., debit card data, credit card data, bank account data, etc.), coupons and other promotional offers, event tickets, lottery tickets, parking tickets, legal documents (i.e., ID cards, driver's license, passport, insurance cards, etc.), loyalty cards, public transportation passes, access key cards, digital certificates, etc. Not only is the wallet device 22 capable of utilizing such data in physical environments (via interacting with the at least one vendor device 24), but it also allows the user to access and utilize the data in online or otherwise electronic environments in at least one embodiment—thereby eliminating the need to store such data on third party cloud servers. Furthermore, because all of the data is stored locally on the wallet device 22, in at least one embodiment, the system 20 is capable of being completely independent from mobile device manufacturers and service provides, as it does not need to rely on any specific types of smartphones or tablets (though, again, the wallet device 22 may selectively communicate with such devices in at least one embodiment, as discussed above). Relatedly, since the wallet device 22 is not connected to public networks and the wallet application 30 software cannot be easily updated, in at least one embodiment, there is a very reduced chance of the wallet device 22 being hacked by malicious software.

It should be noted that the specific applications of the system 20 described herein are merely exemplary and are being provided for illustrative purposes. As such, the system 20 and associated methods described herein should not be read as being so limited, but instead can be utilized in any context, now known or later conceived, where there is a need for securely storing, transmitting and processing select data related to the user of the wallet device 22.

Regardless of the context in which the system 20 is implemented, in at least one embodiment, for transactions requiring user authentication (or for simply accessing the wallet application 30, such as when powering on the wallet device 22 or waking it from stand-by mode), the wallet application 30 restricts access to the stored data using a unique PIN or passcode that is only known to the user. Depending on the embodiment, this secret value may be entered into the wallet device 22 either via the touchscreen wallet display 42 or the microphone 78 via an appropriate voice command. In at least one embodiment, the same PIN or passcode is used for all user-related data stored by the wallet device 22, so that the user is only required to remember a single PIN or passcode (rather than a separate PIN or passcode for each discrete item stored by the wallet device 22).

### EXAMPLES

### Local Payment Transactions

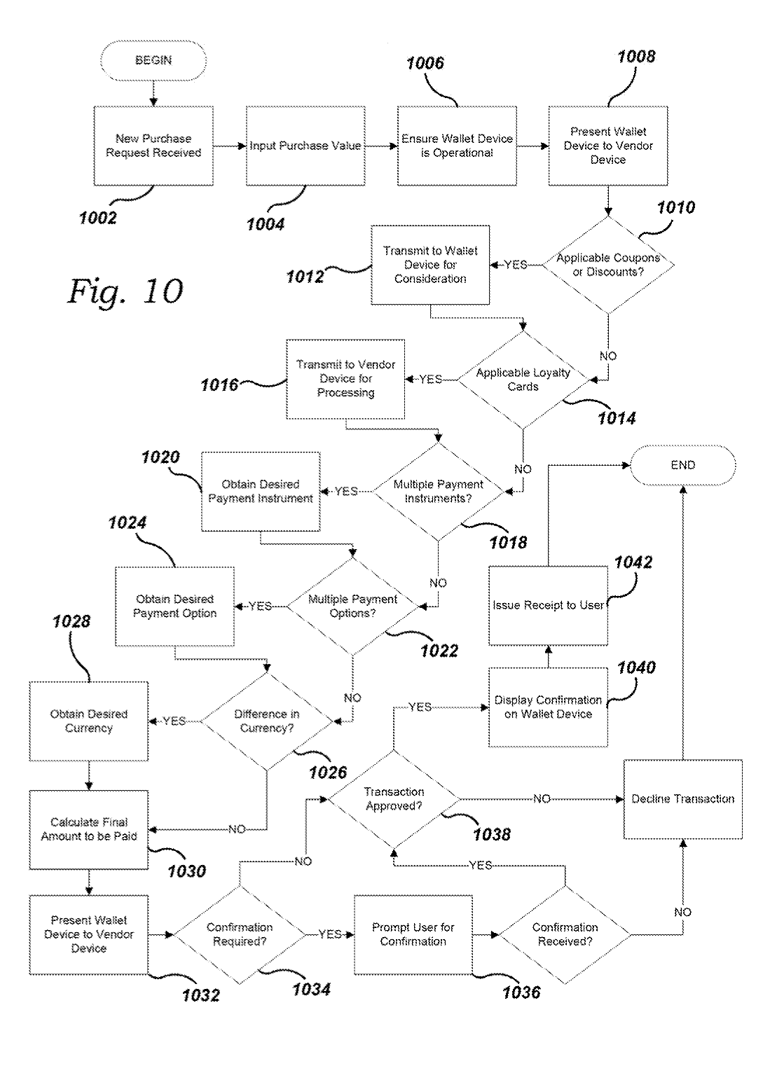

One exemplary context in which the system 20 may be utilized is local payment transactions (i.e., payment transactions where the wallet device 22 is local to the vendor device 24 such that select data may be transferred between the wallet and vendor transceivers 46 and 54). In a bit more detail, and by way of example, in at least one embodiment, as illustrated in the flow diagram of FIG. 10, the vendor is a retail store and the vendor system 28 is a POS system located in the retail store. Upon the user of the wallet device 22 desiring to purchase goods and/or services from the vendor (1002), the vendor first inputs the amount to be charged into the vendor application 34 of the vendor device 24 (1004)—either directly or via the vendor system 28. The user then ensures the wallet device 22 is awake and operational (1006)—by pressing the stand-by button 74 and inputting the appropriate PIN or passcode in at least one embodiment. The wallet device 22 is then presented (1008) by positioning the wallet device 22 and/or wristband 88 in front of the vendor device 24 such that the wallet and vendor transceivers 46 and 54 may communicate with one another. If the vendor device 24 determines that there are applicable coupons, offers, or discounts available for the particular goods or services being purchased (1010), the vendor device 24 transmits them to the wallet device 22 to be displayed via the wallet display 42 for the user's consideration (1012). Additionally, if the wallet device 22 contains loyalty card data related to the vendor (1014), it is transmitted to the vendor device 24 for processing (1016)—i.e., for further discounts and/or reward points in connection with the present transaction. If the wallet device 22 contains more than one payment instrument (1018)—i.e., credit card data, debit card data, checking account data, etc.—the user is prompted to select a desired payment instrument via the wallet display 42 (1020). Furthermore, if the chosen payment instrument provides more than one payment option (1022)—i.e., revolving payments, installment payments, etc.—the user is prompted to select a desired payment option via the wallet display 42 (1024). Still further, if the chosen payment instrument is nominated in a currency type different to that of the vendor yet eligible for currency conversion (1026), the user is prompted via the wallet display 42 to select between paying in the user's own currency or in the vendor's currency (1028). Based on these user selections, the vendor device (or vendor system) calculates the final amount to be paid (1030), at which point the user is prompted to present the wallet device once again (1032). If the payment transaction requires confirmation (1034), the user is prompted via the wallet display 42 (1036) to either touch the wallet display 42 or speak an appropriate voice command—depending on the embodiment. If the payment is approved (1038), a confirmation is displayed via the wallet display (1040), and a digital receipt may optionally be generated by the vendor device (or vendor system) and sent to an email address associated with the user (1042). Alternatively, or additionally, if the wallet device is paired with a mobile device and the connection is active, the wallet device may send a notification to the mobile device to store the purchase information within the associated mobile application.

### Remote Payment Transactions

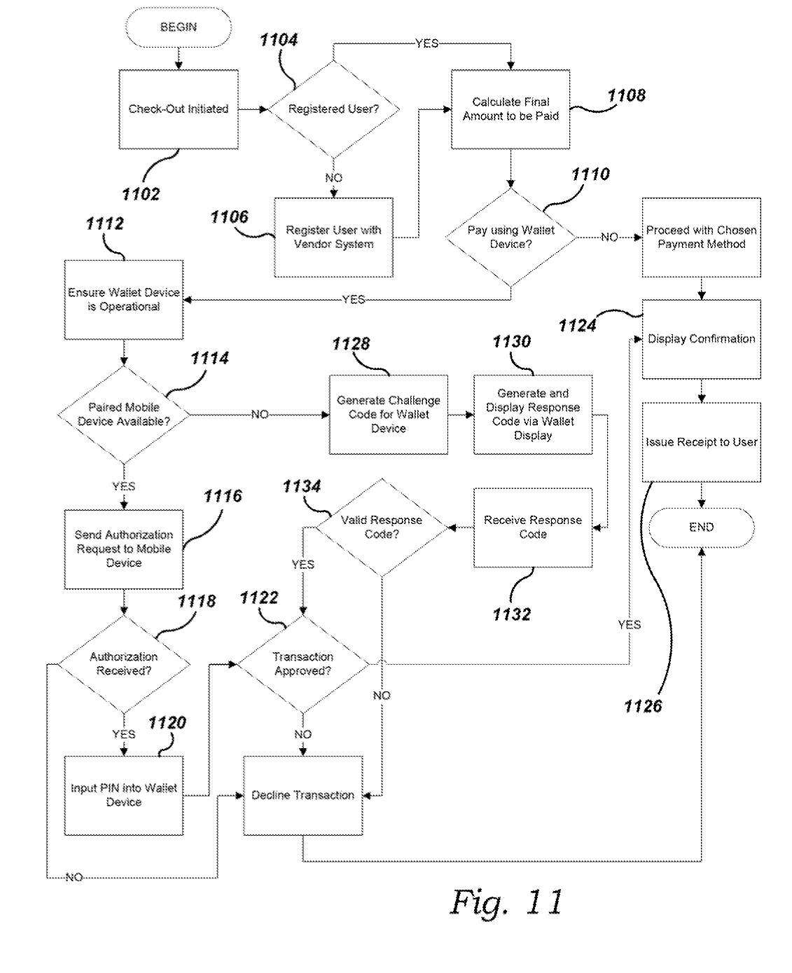

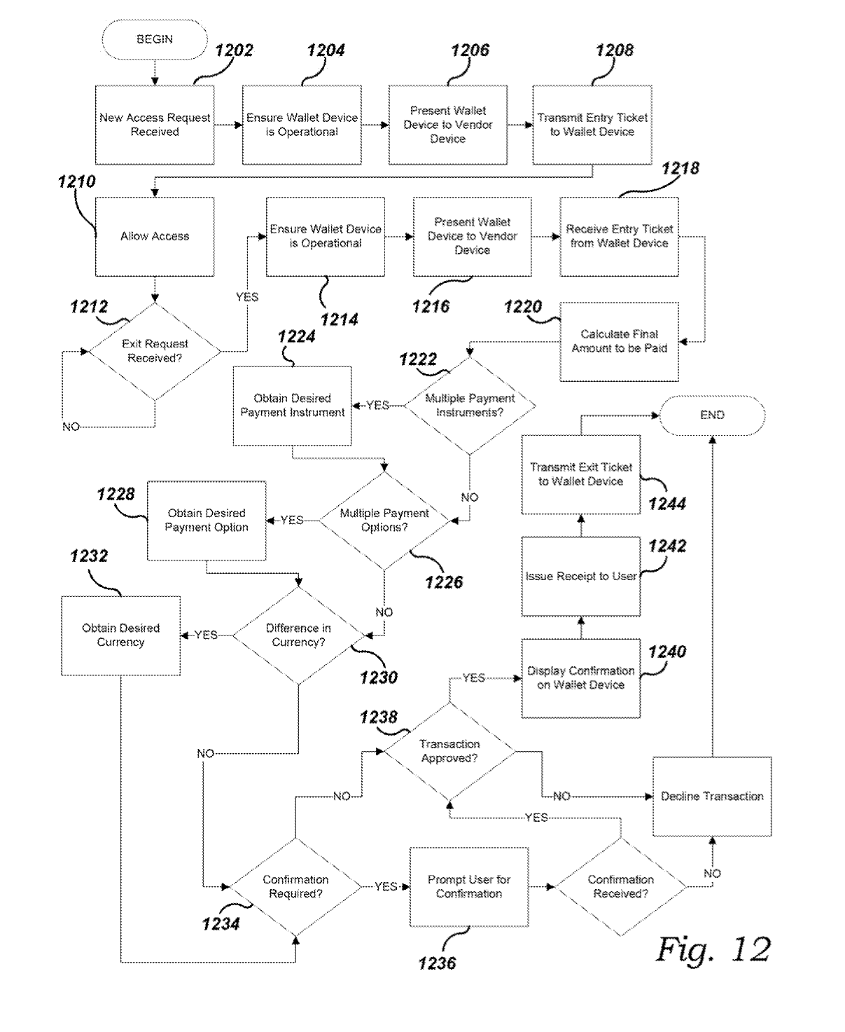

Another exemplary context in which the system 20 may be utilized is remote payment transactions (i.e., payment transactions where the wallet device 22 is not local to the vendor device 24). In a bit more detail, and by way of example, in at least one embodiment, as illustrated in the flow diagram of FIG. 11, the vendor is an e-commerce website. Upon the user of the wallet device 22 adding goods and/or services to their virtual shopping cart—via the mobile device 26 or some other electronic or computing device—and initiating the vendor's check-out procedure (1102), it is first determined whether the user is already registered in the associated vendor system 28 (1104). If not, then the user is registered in the vendor system 28 (1106) by obtaining and storing select data related to at least one of the user, the wallet device 22, and the user's mobile device 26, including the associated Mobile Station International Subscriber Directory Number (“MSISDN”) and data associated with at least one payment instrument. Once the user is registered, the vendor system 28 calculates the final amount to be paid (1108), at which point the user is presented with payment options, one of which being to pay using the wallet device 22 (1110). If chosen, the user is prompted to ensure the wallet device 22 is awake and operational (1112)—by pressing the stand-by button 74 and inputting the appropriate PIN or passcode in at least one embodiment. If the wallet device 22 is paired with the mobile device 26 and the connection is active (1114), the vendor system 28 sends a notification to the mobile device 26 requesting authorization to proceed with the payment (1116). If the user accepts the request (1118), the user is prompted to input the appropriate PIN or passcode into the wallet device 22 (1120). If the payment is approved (1122), a confirmation is displayed via the vendor website (1124), and a digital receipt may optionally be generated by the vendor system 28 and sent to an email address associated with the user (1126). Alternatively, or additionally, the vendor system 28 may send a notification to the mobile device 26 to store the purchase information within the associated mobile application. It should be noted that in certain contexts, such as the above example, the vendor device 24 may be omitted from, or at least not utilized in, the system 20.

Alternatively, if the wallet device 22 is not paired with the mobile device 26, the vendor system 28 generates a challenge code via the vendor website (1128) and prompts the user to enter that code into the wallet device 22. Once the user enters the challenge code into the wallet device 22, the wallet application 30 then calculates and displays—or audibly recites, depending on the embodiment—a corresponding response code (1130) for the user to enter into the vendor website (1132). If the response code is approved (1134), the vendor system 28 processes the payment. And if the payment is approved (1122), a confirmation is displayed via the vendor website (1124), and a digital receipt may optionally be generated by the vendor system 28 and sent to an email address associated with the user (1126).

A similar method may be employed in the context of telephone orders; though, rather than the user receiving and entering challenge-response codes via a vendor website, the challenge-response codes are verbally conveyed via a telephone operator associated with the vendor. Furthermore, a similar method may also be employed in the context of local payment transactions, where the vendor device 24 and/or vendor system 28 is experiencing technical difficulties and is unable to function as described above, causing a vendor employee to contact a telephone operator associated with the vendor to help complete the transaction.

### Access Control Transactions

Another exemplary context in which the system 20 may be utilized is access control transactions and identity verification. In a bit more detail, and by way of example, in at least one embodiment, as illustrated in the flow diagram of FIG. 12, the vendor system 28 is an access control device, such as an unattended terminal for a parking lot. Upon the user of the wallet device 22 desiring to gain access to the parking lot (1202), the user ensures the wallet device 22 is awake and operational (1204)—by pressing the stand-by button 74 and inputting the appropriate PIN or passcode in at least one embodiment. The wallet device 22 is then presented to the vendor device 24 (1206). The vendor device 24 transmits an entry ticket to the wallet device 22 (1208) and subsequently allows the user to enter the parking lot (1210). Upon the user desiring to exit the parking lot (1212), the user again ensures the wallet device 22 is awake and operational (1214) and then presents the wallet device 22 to the vendor device 24 (1216). The wallet device 22 then transmits the entry ticket to the vendor device 24 (1218), and the vendor device 24 (or vendor system 28) calculates the final amount to be paid (1220). If the wallet device 22 contains more than one payment instrument (1222)—i.e., credit card data, debit card data, checking account data, etc.—the user is prompted to select a desired payment instrument via the wallet display 42 (1224). Furthermore, if the chosen payment instrument provides more than one payment option (1226)—i.e., revolving payments, installment payments, etc.—the user is prompted to select a desired payment option via the wallet display 42 (1228). Still further, if the chosen payment instrument is nominated in a currency type different to that of the vendor yet eligible for currency conversion (1230), the user is prompted via the wallet display 42 to select between paying in the user's own currency or in the vendor's currency (1232). If the payment transaction requires confirmation (1234), the user is prompted via the wallet display 42 (1236) to either touch the wallet display 42 or speak an appropriate voice command—depending on the embodiment. If the payment is approved (1238), a confirmation is displayed via the wallet display 22 (1240), and a digital receipt may optionally be generated by the vendor device 24 (or vendor system 28) and sent to an email address associated with the user (1242). Additionally, in at least one embodiment, the vendor device 24 transmits an exit ticket to the wallet device 22 (1244) to then present to another vendor device 24 interconnected with an exit barrier.

Similar methods may be utilized in virtually any context where access control and/or identity verification is needed, such as turnstiles, toll roads, vending machines, unattended machines, office doors, hotel rooms, etc. Furthermore, in the context of temporary lodging providers, such as hotels and motels, the vendor device 24 may be configured for generating, and the wallet device 22 configured for storing, key card data in lieu of a physical room key—the door lock of each room (and other facilities controlled by the lodging provider) then providing a separate vendor device 24 for receiving and verifying said key card data when the wallet device 22 is presented thereto.

Aspects of the present specification may also be described as follows:

1. An electronic wallet system comprising: an at least one wallet device in the possession of a user and configured for securely storing data related to said user, each of the at least one wallet device comprising: a portable wallet housing; an at least one wallet display positioned on the wallet housing and configured for allowing the user to selectively interact with the wallet device; a wallet transceiver positioned on the wallet housing and configured for sending and receiving data related to said user; an at least one rechargeable wallet battery positioned within the wallet housing and configured for selectively powering said wallet device; and an at least one wallet charging contact positioned on the wallet housing and configured for selectively powering the wallet device and charging the wallet battery when placed in contact with an appropriate charging unit; and an at least one vendor device in the possession of a vendor and configured for selectively interacting with the at least one wallet device, each of the at least one vendor device comprising: a vendor housing; a vendor transceiver positioned on the vendor housing and configured for sending and receiving select data to and from the wallet transceiver of the at least one wallet device; and an at least one vendor charging contact positioned on the vendor housing and configured for transferring power to the wallet device when the corresponding at least one wallet charging contact is selectively placed into contact therewith; whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

2. The electronic wallet system according to embodiment 1, wherein each of the wallet transceiver and vendor transceiver is an infrared transceiver.

3. The electronic wallet system according to embodiments 1-2, wherein the at least one wallet display is a touchscreen.

4. The electronic wallet system according to embodiments 1-3, wherein the at least one wallet display is positioned on a front face of the wallet housing.

5. The electronic wallet system according to embodiments 1-4, wherein the wallet transceiver is positioned on an opposing rear face of the wallet housing.

6. The electronic wallet system according to embodiments 1-5, wherein the at least one wallet charging contact is positioned on the rear face of the wallet housing.

7. The electronic wallet system according to embodiments 1-6, wherein the vendor transceiver is positioned on a front face of the vendor housing.

8. The electronic wallet system according to embodiments 1-7, wherein the at least one vendor device further comprises a wallet dock positioned on the front face of the vendor housing, the wallet dock sized and configured for removably receiving the wallet device therewithin.

9. The electronic wallet system according to embodiments 1-8, wherein the vendor transceiver and at least one vendor charging contact are positioned within the wallet dock and substantially aligned with the wallet transceiver and at least one wallet charging contact, respectively, when the wallet device is engaged with the wallet dock.

10. The electronic wallet system according to embodiments 1-9, wherein the wallet dock provides a pair of opposing, spaced apart spring pin arrays positioned and configured such that the spring pins selectively index into corresponding retaining holes positioned along a side wall of the wallet housing.

11. The electronic wallet system according to embodiments 1-10, wherein the at least one vendor device further comprises an at least one rechargeable vendor battery positioned within the vendor housing and configured for selectively powering said vendor device.

12. The electronic wallet system according to embodiments 1-11, wherein the at least one wallet device is configured for going into a “stand-by” mode, after a pre-defined period of inactivity has elapsed, the wallet device further providing a stand-by button positioned on the wallet housing and configured for selectively waking the wallet device when it is in stand-by mode.

13. The electronic wallet system according to embodiments 1-12, wherein the at least one wallet device further comprises an at least one microphone positioned on the wallet housing and configured for receiving voice commands from the user.

14. The electronic wallet system according to embodiments 1-13, wherein the at least one wallet device further comprises at least one of an audio jack and a speaker positioned on the wallet housing.

15. The electronic wallet system according to embodiments 1-14, wherein the at least one wallet device further comprises an at least one removable memory unit configured for securely storing select data related to the user.

16. The electronic wallet system according to embodiments 1-15, wherein the at least one wallet device further provides a USB port positioned on the wallet housing.

17. The electronic wallet system according to embodiments 1-16, wherein the at least one vendor device further comprises a USB port positioned on the vendor housing.

18. The electronic wallet system according to embodiments 1-17, wherein the at least one vendor device further comprises an at least one vendor display positioned on the vendor housing.

19. The electronic wallet system according to embodiments 1-18, further comprising an at least one mobile device in selective communication with said at least one wallet device.

20. The electronic wallet system according to embodiments 1-19, further comprising an at least one vendor system in communication with said at least one vendor device.

21. The electronic wallet system according to embodiments 1-20, wherein the at least one wallet device provides a wallet application residing in memory on said wallet device.

22. The electronic wallet system according to embodiments 1-21, wherein the at least one vendor device provides a vendor application residing in memory on said vendor device.

23. The electronic wallet system according to embodiments 1-22, wherein the at least one wallet device further comprises a wristband comprising: a strap portion configured for being removably engaged around the user's wrist; a wallet receptacle sized and configured for removably receiving the wallet device therewithin; an at least one transceiver relay positioned and configured for interfacing with the wallet transceiver, when the wallet device is engaged with the wallet receptacle, so as to relay data signals to and from the wallet transceiver; and an at least one transmission line embedded in the strap portion and interconnecting each of the at least one transceiver relay and the wallet transceiver.

24. The electronic wallet system according to embodiments 1-23, wherein the wallet receptacle provides a pair of opposing, spaced apart spring pin arrays positioned and configured such that the spring pins selectively index into corresponding retaining holes positioned along a side wall of the wallet housing.

25. The electronic wallet system according to embodiments 1-24, wherein the wristband further comprises: a first transceiver relay positioned on the wallet receptacle such that, when the wallet device is engaged with the wallet receptacle, the first transceiver relay is substantially aligned with the wallet transceiver; and a second transceiver relay in a position substantially opposite to that of the first transceiver relay so as to allow the data signals to be relayed to and from the wallet transceiver in two substantially opposing directions; whereby, the user is able to selectively orient the wallet device in two different positions when interacting with the vendor device.

26. The electronic wallet system according to embodiments 1-25, wherein the strap portion is relatively elongate, having opposing free ends, and provides a closure portion configured for selectively securing the free ends to one another for engagement around the user's wrist.

27. The electronic wallet system according to embodiments 1-26, wherein the second transceiver relay is positioned within the closure portion.

28. An electronic wallet system comprising: an at least one wallet device in the possession of a user and configured for securely storing data related to said user, each of the at least one wallet device comprising: a portable wallet housing; an at least one wallet display positioned on a front face of the wallet housing and configured for allowing the user to selectively interact with the wallet device; a wallet transceiver positioned on an opposing rear face of the wallet housing and configured for sending and receiving data related to said user; an at least one rechargeable wallet battery positioned within the wallet housing and configured for selectively powering said wallet device; an at least one wallet charging contact positioned on the wallet housing and configured for selectively powering the wallet device and charging the wallet battery when placed in contact with an appropriate charging unit; and an at least one vendor device in the possession of a vendor and configured for selectively interacting with the at least one wallet device, each of the at least one vendor device comprising: a vendor housing; a wallet dock positioned on a front face of the vendor housing, the wallet dock sized and configured for removably receiving the wallet device therewithin; an at least one vendor charging contact positioned within the wallet dock for contacting the at least one wallet charging contact when the wallet device is engaged with the wallet dock, the at least one vendor charging contact configured for transferring power to the wallet device; and a vendor transceiver positioned on the front face of the vendor housing and configured for sending and receiving select data to and from the wallet transceiver of the at least one wallet device; whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

29. An electronic wallet system comprising: an at least one wallet device in the possession of a user and configured for securely storing data related to said user, each of the at least one wallet device comprising: a portable wallet housing; an at least one wallet display positioned on the wallet housing and configured for allowing the user to selectively interact with the wallet device; an infrared wallet transceiver positioned on the wallet housing and configured for sending and receiving data related to said user; and a wristband comprising: a strap portion configured for being removably engaged around the user's wrist; a wallet receptacle sized and configured for removably receiving the wallet device therewithin; and an at least one transceiver relay positioned and configured for interfacing with the wallet transceiver, when the wallet device is engaged with the wallet receptacle, so as to relay data signals to and from the wallet transceiver; and an at least one vendor device in the possession of a vendor and configured for selectively interacting with the at least one wallet device, each of the at least one vendor device comprising: a vendor housing; and an infrared vendor transceiver positioned on the vendor housing and configured for sending and receiving select data to and from the wallet transceiver of the at least one wallet device; whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

In closing, regarding the exemplary embodiments of the present invention as shown and described herein, it will be appreciated that an electronic wallet system and associated methods of use are disclosed. Because the principles of the invention may be practiced in a number of configurations beyond those shown and described, it is to be understood that the invention is not in any way limited by the exemplary embodiments, but is generally directed to an electronic wallet system and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An electronic wallet system comprising:
an at least one wallet device in the possession of a user and configured for securely storing data related to said user, each of the at least one wallet device comprising:
a portable wallet housing;
an at least one wallet display positioned on the wallet housing and configured for allowing the user to selectively interact with the wallet device;
a wallet transceiver positioned on the wallet housing and configured for sending and receiving data related to said user;
an at least one rechargeable wallet battery positioned within the wallet housing and configured for selectively powering said wallet device; and
an at least one wallet charging contact positioned on the wallet housing and configured for selectively powering the wallet device and charging the wallet battery when placed in contact with an appropriate charging unit; and
an at least one vendor device in the possession of a vendor and configured for selectively interacting with the at least one wallet device, each of the at least one vendor device comprising:
a vendor housing;
a vendor transceiver positioned on the vendor housing and configured for sending and receiving select data to and from the wallet transceiver of the at least one wallet device; and
an at least one vendor charging contact positioned on the vendor housing and configured for transferring power to the wallet device when the corresponding at least one wallet charging contact is selectively placed into contact therewith;
whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

2. The electronic wallet system of claim 1, wherein each of the wallet transceiver and vendor transceiver is an infrared transceiver.

3. The electronic wallet system of claim 1, wherein the at least one wallet display is a touchscreen.

4. The electronic wallet system of claim 1, wherein:
the at least one wallet display is positioned on a front face of the wallet housing;
the wallet transceiver is positioned on an opposing rear face of the wallet housing; and
the vendor transceiver is positioned on a front face of the vendor housing.

5. The electronic wallet system of claim 4, wherein the at least one vendor device further comprises a wallet dock positioned on the front face of the vendor housing, the wallet dock sized and configured for removably receiving the wallet device therewithin.

6. The electronic wallet system of claim 5, wherein the vendor transceiver and at least one vendor charging contact are positioned within the wallet dock and substantially aligned with the wallet transceiver and at least one wallet charging contact, respectively, when the wallet device is engaged with the wallet dock.

7. The electronic wallet system of claim 6, wherein the at least one wallet charging contact is positioned on the rear face of the wallet housing.

8. The electronic wallet system of claim 6, wherein the wallet dock provides a pair of opposing, spaced apart spring pin arrays positioned and configured such that the spring pins selectively index into corresponding retaining holes positioned along a side wall of the wallet housing.

9. The electronic wallet system of claim 1, wherein the at least one wallet device further comprises an at least one microphone positioned on the wallet housing and configured for receiving voice commands from the user.

10. The electronic wallet system of claim 1, wherein the at least one wallet device further comprises at least one of an audio jack and a speaker positioned on the wallet housing.

11. The electronic wallet system of claim 1, wherein the at least one wallet device further comprises an at least one removable memory unit configured for securely storing select data related to the user.

12. The electronic wallet system of claim 1, wherein the at least one vendor device further comprises an at least one vendor display positioned on the vendor housing.

13. The electronic wallet system of claim 1, further comprising an at least one mobile device in selective communication with said at least one wallet device.

14. The electronic wallet system of claim 1, further comprising an at least one vendor system in communication with said at least one vendor device.

15. The electronic wallet system of claim 1, wherein the at least one wallet device further comprises a wristband comprising:
a strap portion configured for being removably engaged around the user's wrist;
a wallet receptacle sized and configured for removably receiving the wallet device therewithin;
an at least one transceiver relay positioned and configured for interfacing with the wallet transceiver, when the wallet device is engaged with the wallet receptacle, so as to relay data signals to and from the wallet transceiver; and
an at least one transmission line embedded in the strap portion and interconnecting each of the at least one transceiver relay and the wallet transceiver.

16. The electronic wallet system of claim 15, wherein the wallet receptacle provides a pair of opposing, spaced apart spring pin arrays positioned and configured such that the spring pins selectively index into corresponding retaining holes positioned along a side wall of the wallet housing.

17. The electronic wallet system of claim 15, wherein the wristband further comprises:
a first transceiver relay positioned on the wallet receptacle such that, when the wallet device is engaged with the wallet receptacle, the first transceiver relay is substantially aligned with the wallet transceiver; and
a second transceiver relay in a position substantially opposite to that of the first transceiver relay so as to allow the data signals to be relayed to and from the wallet transceiver in two substantially opposing directions;
whereby, the user is able to selectively orient the wallet device in two different positions when interacting with the vendor device.

18. The electronic wallet system of claim 17, wherein:
the strap portion is relatively elongate, having opposing free ends, and provides a closure portion configured for selectively securing the free ends to one another for engagement around the user's wrist; and
the second transceiver relay is positioned within the closure portion.

19. An electronic wallet system comprising:
an at least one wallet device in the possession of a user and configured for securely storing data related to said user, each of the at least one wallet device comprising:
a portable wallet housing;
an at least one wallet display positioned on a front face of the wallet housing and configured for allowing the user to selectively interact with the wallet device;
a wallet transceiver positioned on an opposing rear face of the wallet housing and configured for sending and receiving data related to said user;
an at least one rechargeable wallet battery positioned within the wallet housing and configured for selectively powering said wallet device;
an at least one wallet charging contact positioned on the wallet housing and configured for selectively powering the wallet device and charging the wallet battery when placed in contact with an appropriate charging unit; and
an at least one vendor device in the possession of a vendor and configured for selectively interacting with the at least one wallet device, each of the at least one vendor device comprising:
a vendor housing;
a wallet dock positioned on a front face of the vendor housing, the wallet dock sized and configured for removably receiving the wallet device therewithin;
an at least one vendor charging contact positioned within the wallet dock for contacting the at least one wallet charging contact when the wallet device is engaged with the wallet dock, the at least one vendor charging contact configured for transferring power to the wallet device; and
a vendor transceiver positioned on the front face of the vendor housing and configured for sending and receiving select data to and from the wallet transceiver of the at least one wallet device;
whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.

20. An electronic wallet system comprising:
an at least one wallet device in the possession of a user and configured for securely storing data related to said user, each of the at least one wallet device comprising:
a portable wallet housing;
an at least one wallet display positioned on the wallet housing and configured for allowing the user to selectively interact with the wallet device;
an infrared wallet transceiver positioned on the wallet housing and configured for sending and receiving data related to said user; and
a wristband comprising:
a strap portion configured for being removably engaged around the user's wrist;
a wallet receptacle sized and configured for removably receiving the wallet device therewithin; and
an at least one transceiver relay positioned and configured for interfacing with the wallet transceiver, when the wallet device is engaged with the wallet receptacle, so as to relay data signals to and from the wallet transceiver; and
an at least one vendor device in the possession of a vendor and configured for selectively interacting with the at least one wallet device, each of the at least one vendor device comprising:
a vendor housing; and
an infrared vendor transceiver positioned on the vendor housing and configured for sending and receiving select data to and from the wallet transceiver of the at least one wallet device;
whereby, the at least one wallet device is capable of securely storing, transmitting and processing all pertinent data related to, and handling nearly every operation the user could potentially perform with, any item traditionally stored in a physical wallet, thereby eliminating the need for the user to physically carry such items.
